(19) United States
(12) Patent Application Publication
(10) Pub. No.: US 2012/0231284 A1
(43) Pub. Date: Sep. 13, 2012

(54) PROCESS FOR COATING PLASTIC OR METAL SURFACES

(75) Inventors: Heike Pfistner, Ludwigshafen (DE); Andreas Fechtenkötter, Singapore (SG); Frank-Olaf Mähling, Mannheim (DE); Helmut Witteler, Wachenheim (DE); Frank Dietsche, Schriesheim (DE); Stefan Faßbender, Speyer (DE); Claudia Simon, Waldsee (DE)

(73) Assignee: BASF SE, Ludwigshafen (DE)

(21) Appl. No.: 13/472,234

(22) Filed: May 15, 2012

Related U.S. Application Data
(62) Division of application No. 12/302,292, filed on Nov. 25, 2008.

(30) Foreign Application Priority Data
May 30, 2006 (EP) 06114689.0

(51) Int. Cl. B32B 15/08; C08F 220/06; B32B 27/08; C09D 5/00

(52) U.S. Cl. 428/461; 524/556; 526/318.6; 428/515

(57) ABSTRACT

A method of coating surfaces of plastic or metal, which comprises treating the plastic or metal surface in question with an aqueous dispersion comprising
(A) at least one ethylene copolymer having a molecular weight Mₙ in the range from 2000 to 20 000 g/mol, selected from ethylene copolymers comprising as comonomers in copolymerized form
   (a) 15.5% to 19.9% by weight of at least one ethylenically unsaturated C₃-C₁₀ carboxylic acid and
   (b) 80.1% to 84.5% by weight of ethylene,
(B) at least one base,
   in one step and subsequently providing in at least one further step the metal or plastic surface in question with at least one further coat.

The present invention relates to a method of coating surfaces of plastic or of metal in at least two steps, which involves treating in one step the plastic or metal surface in question with an aqueous dispersion comprising
(A) at least one ethylene copolymer having a molecular weight Mₙ in the range from 2000 to 20 000 g/mol, selected from ethylene copolymers comprising as comonomers in copolymerized form
   (a) 15.5% to 19.9% by weight of at least one ethylenically unsaturated C₃-C₁₀ carboxylic acid and
   (b) 80.1% to 84.5% by weight of ethylene,
(B) at least one base,
   and thereafter providing in at least one further step the metal or plastic surface in question with at least one further coat.

When surfaces, such as those of plastic or of metal, for example, are provided with a coating, such as with a varnish coating or a paint coating, for example, which are intended to give an aesthetically attractive impression, in many cases the metal or plastic surface in question is not coated directly with varnish or paint but is instead first provided with a first coat also referred to as an undercoat or primer. The primer or undercoat is intended to fulfill a variety of functions. For instance, it is intended to enhance the adhesion of varnish or paint to metal or plastic and, for example, to prevent easy flaking. In many cases, furthermore, the primer or undercoat achieves or at least sharply improves the protection afforded to the plastic or metal surface.

In the past, formulations used for the purpose of priming in many cases comprised heavy metal compounds such as Cr(VI) compounds, for example. It is desirable, however, to avoid the use of such formulations, on the grounds of health protection. Primers based on red lead are in many cases also declined by the user on toxicological grounds, especially when the coatings in question may come into contact with foods.

An object which existed was to provide a method of coating surfaces of plastic or metal through which corrosion-protected plastic or metal surfaces of high surface quality are obtained which at the same time have a high level of hardness and can be allowed to come into contact with foods. A further object which existed was that of providing formulations which can be used to coat plastic or metal surfaces effectively.

Accordingly the method defined at the outset was found. Also found were aqueous dispersions with which the method of the invention can be implemented to a particularly good effect, and also a method of preparing the dispersions of the invention. Found in addition were ethylene copolymers with which the method of the invention can be implemented to especially good effect.

The method defined at the outset starts on surfaces of plastic or of metal. Plastic or metal surfaces for inventive coating may be textured, which means for the purposes of the present invention that they may have regularly or irregularly disposed elevations or indentations, or, preferably, can be smooth, smooth meaning that there is no texturing discernible to the naked eye. Plastic or metal surfaces for inventive coating may be flat or curved and may have any desired surface geometry. Thus, for example, metal foils, especially aluminum foils, are also suitable.

Metal surfaces for inventive coating may be made of noble metal, of copper or silver for example, or of base metal, with the term metal embracing alloys as well. By way of example it is possible for inventive metal surfaces to be made of iron, aluminum, nickel, cobalt, chromium, titanium, vanadium, and, in particular, of steel, including stainless steel and V2A-grade steel, and additionally of nonferrous metal, noble or base, such as silver, brass, bronzes, gold or copper, for example.

Plastic surfaces for inventive coating may be made for example of thermoplastic. Suitable plastics are, in particular, polyethylene, polypropylene, polystyrene, and styrene copolymers such as ASA, for example, particularly in the form of films.

In one specific embodiment of the present invention the plastic or metal surface for inventive coating is a hard sheet of metal, especially aluminum, or of plastic.

The method of the invention is practiced by treating in one step the plastic or metal surface in question with an aqueous dispersion comprising
(A) at least one ethylene copolymer having a molecular weight Mₙ in the range from 2000 to 20 000 g/mol, selected from ethylene copolymers comprising as comonomers in copolymerized form
   (a) 15.5% to 19.9% by weight of at least one ethylenically unsaturated C₃-C₁₀ carboxylic acid and
   (b) 80.1% to 84.5% by weight of ethylene,
   also referred in the context of the present invention as ethylene copolymer (A), and
(B) at least one base,
   and thereafter providing in at least one further step the metal or plastic surface in question with at least one further coat.

The aqueous dispersion used may be an aqueous emulsion or suspension.

Ethylene copolymer (A) has a molecular weight Mₙ in the range from 2000 to 20 000 g/mol, preferably 3500 to 15 000 g/mol, determinable for example by gel permeation chromatography (GPC).

Ethylene copolymer (A) is selected from ethylene copolymers comprising as comonomers in copolymerized form
(a) 15.5% to 19.9%, preferably 16% to 19%, by weight of at least one ethylenically unsaturated carboxylic acid and
(b) 80.1% to 84.5%, preferably 81% to 84%, by weight of ethylene, based in each case on total ethylene copolymer (A) employed.

By comonomers comprised in copolymerized form are meant the fractions of comonomer which are incorporated molecularly into ethylene copolymer (A).

As ethylenically unsaturated carboxylic acid (a) it is preferred to select at least one carboxylic acid of the general formula

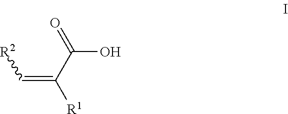

in which the variables are defined as follows:
R¹ and R² are alike or different.
R¹ is selected from hydrogen and
   unbranched and branched C₁-C₁₀ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄ alkyl such as methyl, ethyl, n-propyl, isopropyl, n-butyl, isobutyl, sec-butyl, and tert-butyl; and especially methyl;
R² is selected from unbranched and branched C₁-C₁₀ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄ alkyl such as methyl, ethyl, n-propyl, isopropyl, n-butyl, isobutyl, sec-butyl, and tert-butyl; and especially methyl;
   and with very particular preference hydrogen.

In one embodiment of the present invention R¹ is hydrogen or methyl. With very particular preference R¹ is methyl.

In one embodiment of the present invention R¹ is hydrogen or methyl and R² is hydrogen.

With very particular preference the ethylenically unsaturated carboxylic acid used of the general formula I is methacrylic acid.

If it is desired to use two or more ethylenically unsaturated carboxylic acids to prepare ethylene copolymer (A) then it is possible to employ two different ethylenically unsaturated carboxylic acids of the general formula I such as acrylic acid and methacrylic acid, for example.

In one embodiment of the present invention ethylene copolymer (A) may comprise one or more further comonomers (c) in copolymerized form, examples being isobutene, styrene, one or more C₁-C₁₀ alkyl esters or ω-hydroxy-C₂-C₁₀ alkylene esters of an ethylenically unsaturated C₃-C₁₀ carboxylic acid, such as methyl acrylate, ethyl acrylate, methyl methacrylate, ethyl methacrylate, n-butyl acrylate, 2-hydroxyethyl(meth)acrylate, 2-ethylhexyl(meth)acrylate or n-butyl methacrylate, for example.

In one embodiment of the present invention ethylene copolymer (A) comprises in total up to 10% by weight of one or more comonomers (c) in copolymerized form, based on the sum of (a) and (b).

In another, preferred embodiment of the present invention ethylene copolymer (A) comprises no further comonomer (c) in copolymerized form.

In one embodiment of the present invention ethylene copolymer (A) has a melt flow rate (MFR) in the range from 1 to 150 g/10 min, preferably 5 to 15 g/10 min, more preferably 8 to 12 g/10 min, measured at 160° C. under a load of 325 g in accordance with EN ISO 1133.

In one embodiment of the present invention ethylene copolymer (A) may have an acid number in the range from 100 to 150 mg KOH/g wax, preferably 115 to 130 mg KOH/g wax, determined in accordance with DIN EN 2114.

In one embodiment of the present invention ethylene copolymer (A) has a kinematic melt viscosity v of at least 5000 mm²/s, preferably of at least 10 000 mm²/s, determined at 120° C.

In one embodiment of the present invention the melting range of ethylene copolymer (A) is in the range from 60 to 110° C., preferably in the range from 65 to 90° C., determined by DSC in accordance with DIN 51007.

In one embodiment of the present invention the melting range of ethylene copolymer (A) can be broad and can relate to a temperature interval of at least 7 to not more than 20° C., preferably at least 10° C. and not more than 15° C.

In another embodiment of the present invention the melting point of ethylene copolymer (A) is sharply defined and is situated in a temperature interval of less than 2° C., preferably less than 1° C., determined in accordance with DIN 51007.

In one embodiment of the present invention the density of ethylene copolymer (A) is in the range from 0.89 to 1.10 g/cm³, preferably 0.92 to 0.99 g/cm³, determined in accordance with DIN 53479.

Ethylene copolymers (A) may be alternating copolymers or, preferably, random copolymers.

Inventively used ethylene copolymers (A) of ethylene (b) and ethylenically unsaturated carboxylic acids (a) and, if appropriate, further comonomers (c) may be prepared advantageously by free-radically initiated copolymerization under high-pressure conditions, such as in stirred high-pressure autoclaves or in high-pressure tube reactors, for example, and preferably in combinations of stirred high-pressure autoclaves and high-pressure tube reactors. Stirred high-pressure autoclaves are known per se: a description is found in Ullmann's Encyclopedia of Industrial Chemistry, 5th edition, entry heading: Waxes, Vol. A 28, pp. 146 ff., Verlag Chemie Weinheim, Basle, Cambridge, N.Y., Tokyo, 1996. The length/diameter ratio in such autoclaves is predominantly in ranges from 5:1 to 30:1, preferably 10:1 to 20:1. The high-pressure tube reactors which it is equally possible to employ are likewise found in Ullmann's Encyclopedia of Industrial Chemistry, 5th edition, entry heading: Waxes, Vol. A 28, pp. 146 ff., Verlag Chemie Weinheim, Basle, Cambridge, N.Y., Tokyo, 1996.

Suitable pressure conditions for the copolymerization are 500 to 4000 bar, preferably 1500 to 2500 bar. Conditions of this kind are also referred to below as high pressure. The reaction temperatures are in the range from 170 to 300° C., preferably in the range from 195 to 280° C.

The copolymerization can be carried out in the presence of a regulator. Regulators used include, for example, hydrogen or at least one aliphatic aldehyde or at least one aliphatic ketone of the general formula II

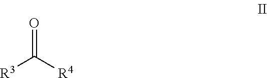

or mixtures thereof.

In this formula the radicals R³ and R⁴ are alike or different and are selected from hydrogen;
C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄ alkyl such as methyl, ethyl, n-propyl, isopropyl, n-butyl, isobutyl, sec-butyl and tert-butyl;
C₃-C₁₂ cycloalkyl such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

In one particular embodiment the radicals R³ and R⁴ are covalently bonded to one another to form a 4- to 13-membered ring. Thus, for example, R³ and R⁴ may together be: —(CH₂)₄—, —(CH₂)₅—, —(CH₂)₅, —(CH₂)₇—, —CH(CH₃)—CH₂—CH₂—CH(CH₃)— or —CH(CH₃)—CH₂—CH₂—CH₂—CH(CH₃)—.

Examples of suitable regulators further include alkylaromatic compounds, examples being toluene, ethylbenzene or one or more isomers of xylene. Examples of highly suitable regulators further include paraffins such as, for example, isododecane (2,2,4,6,6-pentamethylheptane) or isooctane.

Initiators which can be used for the free-radical polymerization are the typical free-radical initiators such as organic peroxides, oxygen or azo compounds, for example. Mixtures of two or more free-radical initiators are suitable as well.

Suitable peroxides, selected from commercially available substances, are for example didecanoyl peroxide, 2,5-dimethyl-2,5-di(2-ethylhexanoylperoxy)hexane, tert-amylperoxy-2-ethylhexanoate, tert-amyl peroxypivalate, tert-butyl peroxypivalate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbonyl)cyclohexane as an isomer mixture, tert-butyl perisononanoate, 1,1-di(tert-butylperoxy)-3,3,5-tri-methylcyclohexane, 1,1-di(tert-butylperoxy)cyclohexane, methyl isobutyl ketone peroxide, tert-butyl peroxyisopropyl carbonate, 2,2-di(tert-butylperoxy)butane or tert-butyl peroxyacetate;

tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropylbenzene monohydroperoxide, cumene hydroperoxide or tert-butyl hydroperoxide; or

dimeric or trimeric ketone peroxides known from EP-A 0 813 550.

Particularly suitable peroxides are di-tert-butyl peroxide, tert-butyl peroxypivalate, tert-amyl peroxypivalate, tert-butyl peroxyisononanoate or dibenzoyl peroxide or mixtures thereof. As an azo compound azobisisobutyronitrile (“AIBN”) may be mentioned by way of example. Free-radical initiators are metered in amounts typical for polymerizations.

Numerous commercially available organic peroxides are admixed with what are called phlegmatizers before being sold, in order to improve their handling properties. Examples of suitable phlegmatizers include white oil or hydrocarbons such as isododecane in particular. Under the conditions of the high-pressure polymerization it is possible that such phlegmatizers may have a molecular weight regulator effect. For the purposes of the present invention the use of molecular weight regulators that are intended to apply the additional use of further molecular weight regulators is to be understood beyond the use of phlegmatizers.

The proportion of the comonomers (a), (b), and, if appropriate, (c) in the case of metered addition typically does not correspond exactly to the proportion of the units in ethylene copolymer (A), since ethylenically unsaturated carboxylic acids are generally incorporated more readily into ethylene copolymer (A) than is ethylene.

Comonomers (a), (b), and, if appropriate, (c) are typically metered together or separately.

Comonomers (a), (b), and, if appropriate, (c) can be compressed in a compressor to the polymerization pressure. In another embodiment of the method of the invention the comonomers are first brought by means of a pump to an increased pressure of, for example, 150 to 400 bar, preferably 200 to 300 bar, and in particular 260 bar, and then brought with a compressor to the actual polymerization pressure.

The copolymerization may optionally be carried out in the absence and in the presence of solvents; mineral oils, white oil, and other solvents present during the polymerization in the reactor and used for the purpose of phlegmatizing the free-radical initiator or initiators are not considered solvents for the purposes of the present invention. Examples of suitable solvents include toluene, isododecane, and isomers of xylene.

Aqueous dispersion used in the first step of the method of the invention further comprises at least one base (B). Base (B) may be, for example, a basic alkali metal salt.

Examples that may be mentioned of basic alkali metal salts include basic potassium salts and especially sodium salts, preference being given to potassium hydroxide, sodium hydroxide, sodium carbonate, potassium carbonate, sodium hydrogen carbonate, potassium hydrogen carbonate. Base (B) preferably comprises volatile bases, more preferably amines such as ethanolamine, diethanolamine, N-methyldiethanolamine, 1-amino-2-propanol, N,N-dimethylethanolamine, diethylenetriamine, ethylenediamine, tetraethylenepentamine, for example, and very preferably ammonia.

In one embodiment of the present invention base (B) comprises a mixture of at least two bases, in particular a mixture of at least one alkali metal hydroxide such as potasslum hydroxide for example or sodium hydroxide, in particular, and ammonia or an organic amine such as ethanolamine, diethanolamine, N-methyldiethanolamine, 1-amino-2-propanol, diethylenetriamine, ethylenediamine or tetraethylenepentamine.

Aqueous dispersion used in the first step in the method of the invention comprises in one embodiment of the present invention sufficient base (B) that the dispersion in question has a pH in the range from 7 to 10, preferably from 8 to 9.5.

In one embodiment of the present invention it is possible for aqueous dispersion used in the first step to have a solids content in the range from 5 to 45%, preferably at least 10%, and more preferably in the range from 15 to 30%.

In one embodiment of the present invention aqueous dispersion used in the first step comprises one or more adjuvants (C), examples being one or more carboxylates such as salts of citric acid, of tartaric acid, of acetic acid, or of oxalic acid, for example, one or more film-forming assistants or one or more antioxidants or particulate solids, examples of those which can be used being as follows:
diatoms, natural products from the calcining of diatomite. The principal constituents are amorphous SiO₂ modifications, accompanied by aluminum oxides, iron oxides, and other elements, and also their silicatic compounds.
Perlites, which are calcined, ground, selected expanded clays of volcanic origin (rhyolites). Their structure is leafletlike and can be described chemically as a sodium, potassium and/or aluminum silicate.
Bentonites, montmorillonites are clay minerals having a high swelling capacity and adsorptiveness.
Synthetic materials, such as polymeric crosslinked particles.

Preference is given to using carbonate particles or silicate particles, especially calcium carbonate and phyllosilicates such as, for example, bentonites or montmorillonites for the purpose of adjusting the tribological properties (friction coefficients) or of adjusting the oxygen permeability, such as talc or mica, for example.

Further suitable adjuvants are anticorrosion pigments, especially Zn salts or organic corrosion inhibitors. In addition it is also possible to add additives which prolong the oxygen diffusion pathway within the paint on account of their high aspect ratio, such as talc or mica, for example, including interface-modified forms thereof.

Examples of suitable antioxidants are ascorbic acid, sterically hindered phenols such as 2,6-di-tert-butyl-para-hydroxytoluene and hydroquinone, for example, and also derivatives of hydroquinone, especially hydroquinone monomethyl ether.

Film-forming assistants that may be named by way of example, selected from alcohols, ethers, and fatty acid esters, can be found in the German Pharmacopoeia (DAB).

In one embodiment of the present invention dispersion used in the first step comprises no emulsifier, i.e., it is emulsifier-free. By emulsifiers in this context are meant cationic, anionic, zwitterionic, and, in particular, nonionic surface-active compounds, examples being ammonium salts of amines having at least one C₁₀-C₄₀ alkyl group, sodium salts or potassium salts of C₁₀-C₄₀ alkyl sulfates or C₁₀-C₄₀ alkylsulfonates or C₈-C₃₀ alkyl-benzenesulfonates, sodium or potassium salts of doubly to vigintuply alkoxylated C₅-C₂₀ alkanols, sodium or potassium salts of natural or synthetic fatty acids, which may be mono- or polyunsaturated or saturated, esterquats, and singly to 100-tuply alkoxylated oxo-process alcohols or fatty alcohols. “No emulsifier or emulsifier-free means that the fraction of the aforementioned compounds in aqueous formulation used in accordance with the invention is lower than 0.1% by weight and is preferably below the detection limit.

The inventively used dispersions further comprise water which is preferably deionized, i.e., has been purified by distillation or by using an ion exchanger.

In one embodiment of the present invention plastic or metal surface is treated with aqueous dispersion comprising ethylene copolymer (A) and base (B) by dipping, spraying, injecting, spreading, knife coating, rolling or electrophoretic coating.

If it is desired to effect the inventive coating by dipping, then the coating takes place with the dip bath in question at a temperature in the range from 15 to 90° C., preferably up to 70° C., and more preferably 20 to 50° C. For this purpose the dip bath which comprises formulation comprising ethylene copolymer (A) and base (B) can be heated. If it is desired in accordance with the invention to coat articles which have a plastic or metal surface, an elevated temperature can also be brought about automatically by immersing the hot metal in question into the dip bath comprising formulation comprising ethylene copolymer (A) and base (B).

If it is desired to carry out the method of the invention by spraying, injecting, spreading, knife coating, rolling or electrophoretic coating, then it is possible to operate preferably at a temperature in the range from 15 to 40° C., preferably 20 to 35° C.

The method of the invention can be performed batchwise or, preferably continuously. A discontinuous method may be, for example, a dipping method for piece goods, where the piece goods may be suspended from racks or may be present as loose product in perforated drums. A continuous method is especially suitable for treating coil metals. The coil metal in this case is passed through a tank or a spraying apparatus with a formulation comprising inventive copolymer, and also, optionally, through further pretreatment or aftertreatment stations.

In one version of the method of the invention the metal or polymer surface is treated by a continuous coil method.

Following the actual application of aqueous formulation comprising ethylene copolymer (A) and base (B), drying takes place. This drying may take place at room temperature by simple evaporation of the volatile components in air at room temperature.

Drying can also be assisted by means of suitable auxiliary means and/or auxiliary measures, such as by heating and/or by passing gas streams, especially air streams, over the systems to be dried, and in particular by means of drying in a drying tunnel. Drying may also be assisted by means of IR lamps. It has been found appropriate to carry out drying at a temperature of 40° C. to 160° C., preferably 50° C. to 150° C., and more preferably 70° C. to 130° C. The temperature referred to is that on the plastic or metal surface; it may be necessary to set a higher dryer temperature. In this context, where it is a plastic surface that is being treated, the temperature is set such that it is at least 5° C. below the softening temperature of the plastic in question.

Drying itself may be preceded by allowing the article to drip dry in order to remove excess formulation. If the coated plastic or metal surface is that of metal sheets or metal foils or plastic films, excess formulation can be removed by squeegeeing or blade stripping, for example.

It is possible to rinse the plastic or metal surface, after the inventive treatment but before the drying operation, with a cleaning liquid, in particular with water, in order to remove excess residues of the formulation employed from the inventively treated plastic or metal surface. This is followed by drying.

It is also possible to carry out the drying in accordance with what is called a “no-rinse” operation. Formulation comprising ethylene copolymer (A) and base (B) is dried immediately after its application, without prior rinsing, in a drying oven.

Through the treatment of plastic and/or metal surfaces with aqueous dispersion which comprises ethylene copolymer (A) and base (B), fractions at least of ethylene copolymer (A) and also of any further components of the aqueous formulation are physisorbed or chemisorbed by the plastic or metal surface, so that a firm bond comes about between plastic or metal surface and ethylene copolymer (A).

In one embodiment of the present invention ethylene copolymer (A) is applied with a coat thickness of 50 nm to 50 μm, preferably 100 nm to 10 μm, more preferably 300 nm to 5 μm. These values apply to ethylene copolymer (A) after drying.

To carry out the method of the invention the plastic or metal surface treated with ethylene copolymer (A) is subsequently provided in at least one further step with at least one further coat.

For this purpose it is possible for example to repeat the first step described above.

In another embodiment of the present invention the surface is provided in the second step of the method of the invention with a different coat or with two or more different coats than in the first step. The coat or coats in the second step may comprise, for example, one or more paint coats, which are known per se and are composed of the constituents typical for paint or varnish coats. These may be, for example, color or effect paint coats. Typical paints, their composition, and typical coat sequences in the case of two or more paint coats are known per se. It is observed that the coating applied in accordance with the invention is highly amenable to overcoating with commercially customary paints.

In one specific version of the method of the invention the treatment with aqueous dispersion comprising ethylene copolymer (A) and base (B) is preceded by the implementation of one or more pretreatment steps.

For the purpose of the pretreatment the plastic or metal surface that is desired to treat inventively with aqueous dispersion comprising ethylene copolymer (A) and base (B), particularly a surface of metal, may first of all be pretreated, cleaned for example, and in particular degreased and/or deoiled. In many embodiments degreasing or deoiling also comprises one or more prior preliminary cleaning steps. After the preliminary cleaning step, carried out if appropriate, contaminating grease or oil, which may have formed, for example, in the form of spots or of an oil or grease layer, is removed in the actual cleaning step by means of at least one cleaning bath, by immersion for example, or by means of at least one cleaning agent for application to the plastic or metal surface to be cleaned, it being possible to apply said agent by spraying, by pouring over the plastic or metal surface to be cleaned, or by spraying using, for example, a hose. The residues of cleaning bath or cleaning agent can be removed subsequently, using one or more successive rinsing baths, for example, and finally the plastic or metal surface is dried. Degreasing and deoiling baths have to be disposed of at regular intervals. For the purpose of disposal the grease or oil accumulated in the degreasing or deoiling bath is separated from the aqueous phase in a further operation. Owing to the presence of surfactants in the degreasing or deoiling bath, further chemicals (demulsifiers, breakers) are required auxiliaries for the disposal. Details of the degreasing and deoiling of metals and also of useful formulations and apparatus for the purpose are set out for example under the entry heading “Metals, Surface Treatment”, in Ullmann's Encyclopedia of Industrial Chemistry, 6th edition, 2000, Wiley-VCH-Verlag GmbH, Weinheim, Germany.

In one embodiment degreasing or deoiling is carried out with an aqueous cleaning or degreasing bath, preferably in an alkaline cleaning bath or an alkaline degreasing bath which comprises as surfactant one or more sulfated polyalkoxylated fatty alcohols or one or more sulfated polyalkoxylated phenols, having in each case, for example, a molecular weight Mₙ in the range from 800 to 3000 g/mol, in a concentration which may be, for example, in the range from 0.01 to 20% by weight, preferably 0.02% to 10% by weight, and more preferably at least 0.1% by weight. Alkaline cleaning or degreasing bath employed may for example have a pH in the range from 8 to 14, preferably at least 9, and more preferably 11 to 13,

Cleaning and degreasing baths, especially alkaline cleaning and degreasing baths, may have a temperature in the range from 10 to 80° C.

The cleaning or degreasing or deoiling can be carried out over a period, for example, in the range from 0.1 to 30 seconds.

The present invention further provides coated plastic or metal surfaces obtainable by the method of the invention. Plastic or metal surfaces of the invention are notable in general for very high surface quality, high hardness and, in those cases where one or more paint coats have been applied in a second step, for excellent paint adhesion.

In one special embodiment of the present invention plastic or metal surfaces of the invention are coated hard sheets of plastic or metal. Inventively coated hard sheets as plastic or metal can be processed to form, for example, blister packs for foods or pharmaceutical products such as tablets or suppositories, for example.

The present invention further provides aqueous dispersions having a pH in the range from 7 to 11, preferably 8 to 9.5, comprising
(A) at least one ethylene copolymer having a molecular weight Mₙ in the range from 2000 to 20 000 g/mol, preferably 3500 to 15 000 g/mol, selected from ethylene copolymers comprising as comonomers in copolymerized form
   (a) 15.5% to 19.9%, preferably 16% to 19%, by weight of methacrylic acid and
   (b) 80.1% to 84.5%, preferably 81% to 84%, by weight of ethylene,
(B) at least one base selected from basic alkali metal salt, preferably alkali metal hydroxide, such as sodium hydroxide or potassium hydroxide for example, and, more preferably, ammonia.

In one embodiment of the present invention aqueous dispersions of the invention comprise no emulsifier. Emulsifiers have been defined above.

In one embodiment of the present invention at least one ethylene copolymer (A) has a melt flow rate (MFR) in the range from 1 to 150 g/10 min, preferably 5 to 15 g/10 min, more preferably 8 to 12 g/10 min, measured at 160° C. under a load of 325 g in accordance with EN ISO 1133.

The other physical properties of the ethylene copolymers (A) employed in aqueous dispersions of the invention have been described above.

Aqueous dispersions of the invention are especially suitable for implementing the method of the invention.

The present invention further provides a method of preparing aqueous dispersions of the invention, also called inventive dispersing method.

The inventive dispersing method is carried out by mixing
(A) at least one ethylene copolymer having a molecular weight Mr, in the range from 2000 to 20 000 g/mol, preferably 3500 to 15 000 g/mol, selected from ethylene copolymers comprising as comonomers in copolymerized form
   (a) 15.5% to 19.9%, preferably 16% to 19%, by weight of methacrylic acid and
   (b) 80.1% to 84.5%, preferably 81% to 84%, by weight of ethylene,
(B) and at least one base selected from basic alkali metal salt, preferably alkali metal hydroxide, such as sodium hydroxide or potassium hydroxide for example, and, more preferably, ammonia
   with one another and with water at a temperature above the melting point of ethylene copolymer (A).

The inventive dispersing method is carried out starting from one or more of the above-described ethylene copolymers (A). This copolymer or these copolymers are placed in a vessel, a flask, an autoclave or a reactor, for example, and the ethylene copolymer or copolymers (A) are heated, water and one or more bases (B), if appropriate further adjuvants (C), are added, the sequence of the addition of water and of the addition of base (B) and also further auxiliaries (C) being arbitrary. If the desired temperature is above 100° C. it is advantageous to operate under increased pressure and to select the vessel accordingly. The resultant emulsion or dispersion is homogenized, by means for example of mechanical or pneumatic stirring or by shaking. Heating is carried out advantageously to a temperature above the melting point of the ethylene copolymer or copolymers (A). Heating takes place advantageously to a temperature which is at least 10° C., with particular advantage to a temperature which is at least 30° C., above the melting point of the ethylene copolymer or copolymers (A).

Where two or more different ethylene copolymers (A) are employed heating takes place to a temperature which is above the melting point of the ethylene copolymer (A) that melts at the highest temperature. Where two or more different ethylene copolymers (A) are employed heating takes place advantageously to a temperature which lies at least 10° C. above the melting point of the ethylene copolymer (A) that melts at the highest temperature. Where two or more different ethylene copolymers (A) are employed heating takes place with particular advantage to a temperature which is at least 30° C. above the melting point of the ethylene copolymer (A) that melts at the highest temperature.

Subsequently the inventive aqueous dispersion thus prepared can be cooled.

The aqueous dispersions prepared by the inventive dispersing method are notable for high stability on storage and can be employed effectively in the above-described treatment method of the invention.

The present invention further provides ethylene copolymers having a molecular weight Mₙ in the range from 2000 to 20 000 g/mol, preferably 3500 to 15 000 g/mol, and a melt flow rate (MFR) in the range from 5 to 15 g/10 min, measured at 160° C. under a load of 325 g in accordance with EN ISO 1133, and comprising as comonomers in copolymerized form
(a) 15.5% to 19.9%, preferably 16% to 19%, by weight of methacrylic acid and
(b) 80.1% to 84.5%, preferably 81% to 84%, by weight of ethylene, as a free acid or in partially or fully neutralized form.

Inventive ethylene copolymer can be neutralized using for example alkali metal hydroxide such as for example sodium hydroxide or potassium hydroxide or with particular preference ammonia, especially in the form of an aqueous solution. Inventive ethylene copolymer can be prepared as described above.

The invention is illustrated by working examples.

### WORKING EXAMPLES

I. Preparation of Inventive Ethylene Copolymer

A high-pressure autoclave as described in the literature (M. Buback et al., Chem. Ing. Tech. 1994, 66, 510) was used to copolymerize ethylene and methacrylic acid. For this purpose ethylene (12.0 kg/h) was fed continuously into the high-pressure autoclave under the reaction pressure of 1700 bar. Separately therefrom the amount of methacrylic acid specified in Table 1 was first compressed to an intermediate pressure of 260 bar and then, with the aid of a further compressor, was fed continuously into the high-pressure autoclave under the reaction pressure of 1700 bar. Separately from this the amount of initiator solution specified in Table 1, consisting of tert-amyl peroxypivalate (in isododecane, for concentration see Table 1), was fed continuously into the high-pressure autoclave under the reaction pressure of 1700 bar. Separately from that the amount of regulator specified in Table 1, consisting of propionaldehyde in isododecane—for concentration see Table 1—was first compressed to an intermediate pressure of 260 bar and then, using a further compressor, was fed continuously into the high-pressure autoclave under the reaction pressure of 1700 bar. The reaction temperature was approximately 210° C. (see Table 1). This gave inventive ethylene copolymer having the analytical data apparent from Table 2.

TABLE 1
Preparation of inventive ethylene copolymers (A)

| | T_{reactor} | Ethylene | MAA | PA in ID | | PO in ID | | Conversion | Discharge |
|---|---|---|---|---|---|---|---|---|---|
| No. | [° C.] | [kg/h] | [ml/h] | [ml/h] | c(PA) | [l/h] | c(PO) | [% by wt.] | (A) [kg/h] |
| (A.1) | 203 | 12 | 490 | 950 | 0.11 | 2.47 | 0.025 | 21 | 2.6 |
| (A.2) | 214 | 12 | 440 | 500 | 0.25 | 2.57 | 0.020 | 18 | 2.3 |
| (A.3) | 210 | 12 | 540 | 980 | 0.25 | 1.53 | 0.025 | 19 | 2.4 |
| (A.4) | 213 | 12 | 575 | 450 | 0.14 | 2.53 | 0.035 | 21 | 2.6 |
| (A.5) | 200 | 12 | 570 | 1100 | 0.11 | 1.61 | 0.025 | 17 | 2.2 |

T_{reactor} means the maximum internal temperature of the high-pressure autoclave.
Abbreviations:
MAA: methacrylic acid,
PA: propionaldehyde,
ID: isododecane (2,2,4,6,6-pentamethylheptane),
PA in ID: solution of propionaldehyde in isododecane, total volume of solution.
PO: tert-amyl peroxypivalate,
c(PA): concentration of PA in ID in percent by volume
c(PO): concentration of PO in ID in mol/l
The conversion is based on ethylene and is expressed in % by weight

TABLE 2
Analytical data of inventive ethylene copolymers (A)

| | Ethylene | MAA | Acid number | | | | |
|---|---|---|---|---|---|---|---|
| | content | content | [mg KOH/g | ν | | Tₘₑₗₜ | ρ |
| No. | [% by wt.] | [% by wt.] | ECW] | [mm²/s] | MFR | [° C.] | [g/cm³] |
| (A.1) | 83.6 | 16.4 | 106.7 | 45 000 | n.d. | n.d. | n.d. |
| (A.2) | 83.2 | 16.8 | 109.4 | n.d. | 74 | n.d. | n.d. |
| (A.3) | 82.3 | 17.7 | 115.6 | 45 000 | n.d. | n.d. | n.d. |
| (A.4) | 82.0 | 18.0 | 117.6 | 45 000 | n.d. | 86.6 | 0.9657 |
| (A.5) | 80.4 | 19.6 | 127.9 | n.d. | 70 | n.d. | n.d. |

The MFR was measured always at 160° C. under a load of 325 g in accordance with EN ISO 1133.
n.d.: not determined.
By “content” it is meant the fraction of copolymerized ethylene or MAA, respectively, in the particular ethylene copolymer.
ν: Dynamic melt viscosity, measured at 120° C. in accordance with DIN 51562.
The ethylene content and methacrylic acid content of the ethylene copolymers of the invention were determined by NMR spectroscopy and by titration (acid number). The acid number of the ethylene copolymer was determined titrimetrically in accordance with DIN 53402. The consumption of KOH corresponds to the methacrylic acid content of the ethylene copolymer.
The density was determined in accordance with DIN 53479. The melting range was determined by DSC (differential scanning calorimetry, differential thermoanalysis) in accordance with DIN 51007.

### II. Inventive Treatment of Metal Surfaces

### II.1 Preparation of Metal Surfaces, General Remarks

The inventive and comparative examples were carried out using metal test panels of Al 99.9, Zn 99.8 or hot-dip or electrolytically galvanized steel (0.01 to 20 μm zinc topping on one side) or construction-grade steel St 1.0037.

In each case a 15% by weight aqueous solution of the respective ethylene copolymer (A) was employed. The aqueous solution of respective ethylene copolymer (A) was homogenized and introduced into a dip bath. The precleaned metal test panels were immersed for the stated time and then dried to constant weight at 80° C. Finally the edges of the coated panels were masked off in order to rule out edge effects in the context of the assessment.

The thickness of the passivation coat was determined by differential weighing before and after exposure of the metal surface to the inventively employed composition and on the assumption that the coat has a density of 1 kg/l. “Coat thickness” below always refers to a parameter determined in this way, irrespective of the actual density of the coat.

The corrosion inhibition effect was determined by means of a salt spray test in a salt spray fog atmosphere in accordance with DIN 50021. The withstand time in the corrosion test was defined differently depending on the nature of the corrosion damage.

Where white spots with a diameter of in general more than 1 mm (Zn oxide or Al oxide, referred to as white rust) were formed, the withstand time reported was the time after which the apparent damage corresponds to rating 8 in DIN EN ISO 10289 of April 2001, Annex B, page 19.

The apparent corrosion damage is assessed using rust extent indices from R10 (no rust phenomena) to R0 (complete rust coverage). Critical for assessing the corrosion stability and hence performance of the system is the time leading to exceedance of rust index R8, i.e., a rust extent of >5%.

In the examples below, alkaline pickling was carried out first of all:

In a plastic trough with two flat electrodes (stainless steel or graphite) which had a greater surface area than the metal test panel in question, a solution of an alkaline bath was used which had the following composition:

20 g NaOH

22 g Na₂CO₃

1 g EDTA-Na4

20 g saturated C₁₃ oxo-process alcohol ethoxylated with an average of 9 equivalents of ethylene oxide [C₁₃(EO)₉]

940 ml distilled water.

The alkaline bath was prepared by dissolving NaOH and Na₂CO₃ in distilled water in succession and with stirring. In parallel with this, [C₁₃(EO)₉] and EDTA-Na₄ were predissolved separately in distilled water, at a temperature of 50° C. in the case of the EDTA-Na4 solution. The aqueous solutions of [C₁₃(EO)₉] and EDTA-Na₄ were subsequently added to the NaOH-Na₂CO₃ solution in a graduated cylinder, cooled to room temperature, and made up to 1000 ml with distilled water.

A metal test panel measuring 50 mm·20 mm·1 mm was wiped down with a paper towel and immersed into the alkaline bath between the electrodes at 10 volts, and connected as the cathode. The voltage was adjusted so that the current strength was 1 A.

After ten seconds the metal test panel was removed from the alkaline bath and rinsed for five seconds under running, fully demineralized water.

III.2.1 Experiment with Copolymer (A.1)

Coating of (A.1) on St 1.0037

Metal test panels pretreated as above were immersed once for 10 seconds in a 15% by weight aqueous solution of (A.1) (test solution) and then dried at room temperature for 60 minutes and at 120° C. for 60 minutes.

Coat thickness: 3.5 μm.

The coated metal test panels showed no changes in terms of color or metallic luster as compared with the untreated test panel.

Residence time to a rating of 8 in a 5% salt spray fog atmosphere at 30° C.: over 10 hours.

III.2.2 Experiment with Copolymer (A.2)

Coating of (A.2) on St 1.0037

Metal test panels pretreated as above were immersed once for 10 seconds in a 15% by weight aqueous solution of (A.2) (test solution) and then dried at room temperature for 60 minutes and at 120° C. for 60 minutes.

Coat thickness: 4 μm.

The coated metal test panels showed no changes in terms of color or metallic luster as compared with the untreated test panel.

Residence time to a rating of 8 in a 5% salt spray fog atmosphere at 30° C.: 8 hours.

III.2.3 Experiment with Copolymer (A.3)

Coating of (A.3) on St 1.0037

Metal test panels pretreated as above were immersed once for 10 seconds in a 15% by weight aqueous solution of (A.3) (test solution) and then dried at room temperature for 60 minutes and at 120° C. for 60 minutes.

Coat thickness: 5.5 μm.

The coated metal test panels showed no changes in terms of color or metallic luster as compared with the untreated test panel.

Residence time to a rating of 8 in a 5% salt spray fog atmosphere at 30° C.: over 18 hours.

### COMPARATIVE EXAMPLES

### Comparative Example C1

“Blank” metal panel without coating

Residence time to a rating of 8 in a 5% salt spray fog atmosphere at 30° C. is less than 1 hour.

### Comparative Example C2

### Passivating Coat with H₃PO₄ (phosphatizing)

Metal test panels were immersed once for 10 seconds in aqueous 0.1% or 0.5% or 1% by weight phosphoric acid.

Residence time to a rating of 8 in a 5% salt spray fog atmosphere at 30° C.: less than 2 hours in each case.

1-13. (canceled)

14. A surface of plastic or of metal coated by a method comprising treating in one step the plastic or metal surface in question with an aqueous dispersion comprising
(A) at least one ethylene copolymer having a molecular weight Mₙ in the range from 2000 to 20 000 g/mol and a melt flow rate (MFR) in the range from 1 to 150 g/10 min, measured at 160° C. under a load of 325 g in accordance with EN ISO 1133, selected from ethylene copolymers comprising as comonomers in copolymerized form
(a) 15.5% to 19.9% by weight of at least one ethylenically unsaturated C₃-C₁₀ carboxylic acid and
(b) 80.1% to 84.5% by weight of ethylene,
(B) at least one base,
and thereafter providing in at least one further step the metal or plastic surface in question with at least one further coat.

15. An aqueous dispersion having a pH in the range from 7 to 10, comprising
(A) at least one ethylene copolymer having a molecular weight Mₙ in the range from 2000 to 20 000 g/mol and a melt flow rate (MFR) in the range from 1 to 150 g/10 min, measured at 160° C. under a load of 325 g in accordance with EN ISO 1133, selected from ethylene copolymers comprising as comonomers in copolymerized form
(a) 15.5% to 19.9% by weight of methacrylic acid and
(b) 80.1% to 84.5% by weight of ethylene,
and
(B) at least one base selected from alkali metal hydroxide and ammonia.

16. The aqueous dispersion according to claim 15, which comprises no emulsifier.

17. A method of preparing an aqueous dispersion according to claim 16, which comprises mixing
(A) at least one ethylene copolymer having a molecular weight Mₙ in the range from 2000 to 20 000 g/mol and a melt flow rate (MFR) in the range from 1 to 150 g/10 min, measured at 160° C. under a load of 325 g in accordance with EN ISO 1133, selected from ethylene copolymers comprising as comonomers in copolymerized form
(a) 15.5% to 19.9% by weight of methacrylic acid and
(b) 80.1% to 84.5% by weight of ethylene,
(B) and at least one base selected from alkali metal hydroxide and ammonia with one another and with water at a temperature above the melting point of ethylene copolymer (A).

18. An ethylene copolymer having a molecular weight Mₙ in the range from 2000 to 20 000 g/mol and a melt flow rate (MFR) in the range from 5 to 15 g/10 min, measured at 160° C. under a load of 325 g in accordance with EN ISO 1133, and comprising as comonomers in copolymerized form
(a) 15.5% to 19.9% by weight of methacrylic acid and
(b) 80.1% to 84.5% by weight of ethylene, as a free acid or in partially or fully neutralized form.
